(19) United States
(12) Patent Application Publication
(10) Pub. No.: US 2024/0253280 A1
(43) Pub. Date: Aug. 1, 2024

(54) INTEGRALLY MOLDED BODY

(71) Applicant: Toray Industries, Inc., Tokyo (JP)

(72) Inventors: Yuki Takahashi, Nagoya-shi, Aichi (JP); Hiroyuki Nakayama, Nagoya-shi, Aichi (JP); Tatsuya Abe, Nagoya-shi, Aichi (JP)

(73) Assignee: Toray Industries, Inc., Tokyo (JP)

(21) Appl. No.: 18/564,416

(22) PCT Filed: Jun. 23, 2022
(86) PCT No.: PCT/JP2022/025102

§ 371 Date: Nov. 27, 2023

(30) Foreign Application Priority Data
Jun. 29, 2021 (JP) 2021-107701

(51) Int. Cl. B29C 45/14; B29L 31/34

(52) U.S. Cl. CPC B29C 45/14811; B29C 45/14336; B29L 2031/3481

(57) ABSTRACT

An integrally molded body includes: a laminate having a design surface on one side; and a resin member joined to an outer peripheral side surface of the laminate and contains discontinuous fibers and a thermoplastic resin, wherein the laminate includes surface layers and a core layer, and has a sandwich structure in which the core layer is sandwiched between the surface layers, each of the surface layers includes a member composed of a fiber-reinforced resin member containing continuous reinforcing fibers and a resin, the core layer is any one of a film, a foam, and a porous base material, a convex portion protruding toward the design surface side is formed in a partial region of the laminate, a flat portion is provided at a maximum height position of the convex portion, and a distance between an extension line extended from the flat portion in an in-plane direction.

### TECHNICAL FIELD

This disclosure relates to an integrally molded body used as a component or a housing of, for example, personal computers, OA devices, mobile phones or the like and suitable for applications requiring lightweight, high strength, and high rigidity as well as thickness reduction.

### BACKGROUND

At present, electric and electronic devices such as personal computers, OA devices, AV devices, mobile phones, telephones, facsimiles, home electric appliances, and toy products are required to be further reduced in size and weight as their portability progresses. As a method of achieving size reduction and weight reduction of such devices, size reduction of constituent components inside the housing, thickness reduction of the housing and the like are exemplified.

Japanese Patent Laid-open Publication No. 2016-49649 discloses an integrally molded body suitable for housing applications that require lightweight, high strength, high rigidity, and thickness reduction, wherein a joint portion is provided at least at a part of end portions of a sandwich structure, the sandwich structure including: a core layer containing discontinuous fibers and a thermoplastic resin; and surface layers (skin layers) containing continuous fibers and a resin, another structure is provided at the joint portion, and the integrally molded body has a region in which a porosity of the core layer in a main body other than the joint portion in the sandwich structure is lower than a porosity of the core layer in the joint portion.

Japanese Patent Laid-open Publication No. 2014-50867 discloses a plate-shaped housing member having a front surface and a rear surface, wherein the rear surface includes: a first surface; and a second surface having a height different from a height of the first surface and having a meandering contour line, and a thickness from the meandering contour line of the second surface to the front surface is different from a thickness from the first surface to the front surface.

However, in the integrally molded body described in JP '649, while the space for installing internal constituent components is widened by thickness reduction, the space acquired only by thickness reduction is insufficient. It is therefore essential to devise a design aspect of the housing in addition to thickness reduction of the housing.

In the housing member described in JP '867, as shown in FIG. 5 of JP '867, the housing member has a stepped portion having different thicknesses, whereby a high-strength laptop personal computer can be provided. However, in the housing member described in JP '867, a metal alloy such as a magnesium alloy is used, and the weight reduction thereof is limited. The housing member having the shape described in JP '867 can also be configured as the sandwich structure as described in JP '649. It is difficult to make the continuous fibers conform to the step shape so that fiber breakage and opening in which the distance between the continuous reinforcing fibers is partially increased occur, and “resin rich” regions and voids are likely to occur. Sink marks of the resin are likely to occur due to a difference in thermal shrinkage of the resin, and there is a problem that mechanical strength and designability are impaired.

Therefore, it could be helpful to provide an integrally molded body that is easy to secure a constituent component installation space inside thereof when used for a housing of, for example, a personal computer, and is also excellent in designability in appearance in addition to high strength, high rigidity, weight reduction, and thickness reduction.

### SUMMARY

We thus provide:

[1] An integrally molded body (C) including:
a laminate (A) having a design surface on one side; and
a resin member (B) that is joined to an outer peripheral side surface of the laminate (A) and that contains discontinuous fibers and a thermoplastic resin, wherein
the laminate (A) includes surface layers and a core layer, and has a sandwich structure in which the core layer is sandwiched between the surface layers,
each of the surface layers includes a member composed of a fiber-reinforced resin member containing continuous reinforcing fibers and a resin,
the core layer is any one selected from a film, a foam, and a porous base material,
a convex portion protruding toward the design surface side is formed in a partial region of the laminate (A),
a flat portion (E) is provided at a maximum height position of the convex portion, and
a distance between an extension line extended from the flat portion (E) in an in-plane direction of the flat portion (E) and an intersection (F) at which a line moved from the extension line in a direction perpendicular to the flat portion (E) intersects the resin member (B) is 0.05 to 4.0 mm.
   [2] The integrally molded body according to [1], wherein
the laminate (A) has a non-design surface on a side opposite to the design surface and a thermoplastic resin layer (D) on the non-design surface,
the resin member (B) has a joint surface with the outer peripheral side surface of the laminate (A) and a joint surface with the thermoplastic resin layer (D), and
the laminate (A) and the resin member (B) are bonded and joined with the thermoplastic resin layer (D) interposed therebetween.
   [3] The integrally molded body according to [1] or [2], wherein a fitting portion into which the resin member (B) enters is provided in a part of the core layer.
   [4] The integrally molded body according to [3], wherein
the core layer is the porous base material,
the laminate (A) has a first joint portion joined to the resin member (B), the first joint portion provided at least in a partial region of an outer peripheral portion of the laminate (A),
the first joint portion has a stepped portion in an in-plane direction of the laminate (A), and
the stepped portion has an inclined surface having an angle θ of 10° to 80° with respect to an in-plane direction of the flat portion (E) provided in the laminate (A).
   [5] The integrally molded body according to [4], wherein a porosity of the porous base material at the first joint portion is lower than a porosity of the porous base material at a region other than the first joint portion.
   [6] The integrally molded body according to any one of [1] to [5], wherein the laminate (A) has a rectangular shape in a top view.

“Joining” is sufficient if a state in which two members are in direct or indirect contact is kept.

“Convex portion” is sufficient if the laminate (A) is formed to protrudes toward the design surface side (that is, such the design surface side is convex) at least at a partial region. Preferably, the laminate (A) protrudes and is curved such that the design surface side of the laminate (A) is entirely convex.

It is thus possible to obtain an integrally molded body that can prevent interference with internal components when used for a housing of, for example, a personal computer or the like, the integrally molded body having a high designability of an outer surface, as well as lightweight, thin body, high strength, and high rigidity.

### BRIEF DESCRIPTION OF THE DRAWINGS

FIG. 1 is a perspective view of an integrally molded body.

FIG. 2 is a plan view of an integrally molded body.

FIG. 3 is a schematic cross-sectional view taken along line A-A′ in FIG. 2.

FIG. 4 is a schematic cross-sectional view of a press mold for molding an integrally molded body having a cross section shown in FIG. 3.

FIG. 5 is a schematic cross-sectional view of the press mold shown in FIG. 4 after press molding.

FIG. 6 is a schematic cross-sectional view of an injection mold for molding an integrally molded body having the cross section shown in FIG. 3.

FIG. 7 is a schematic cross-sectional view of the injection mold shown in FIG. 6 after injection molding.

FIG. 8 is a cross-sectional perspective view of an integrally molded body.

FIG. 9 is an enlarged cross-sectional view showing a joined state in the vicinity of an outer peripheral portion of the integrally molded body shown in FIG. 8.

FIG. 10 is a schematic cross-sectional perspective view of an integrally molded body having another member.

FIG. 11 is a schematic enlarged cross-sectional view showing a joined state in the vicinity of an outer peripheral portion of the integrally molded body shown in FIG. 10.

FIG. 12 is a cross-sectional perspective view in the thickness direction of our integrally molded body, in which the laminate (A) has a sandwich structure including surface layers and a core layer made of a foam.

FIG. 13 is an enlarged cross-sectional view showing a joined state in the vicinity of an outer peripheral portion of the integrally molded body shown in FIG. 12.

FIGS. 14[1] and 14[2] are enlarged cross-sectional views showing a joined state in the vicinity of the outer peripheral portion of our integrally molded body in which the thermoplastic resin layer (D) adheres to the laminate (A).

FIG. 15 is a schematic perspective view of an integrally molded body obtained in Comparative Example 4.

FIG. 16 is a plan view of an integrally molded body obtained in Comparative Example 4.

FIG. 17 is a cross-sectional view of a press mold used in Comparative Example 4.

FIG. 18 is a cross-sectional view of an injection mold used in Comparative Example 4.

FIG. 19 is a cross-sectional perspective view of an integrally molded body (C) 1 including another member, a resin member (B) 3, and a laminate (A) 2.

FIG. 20 is an enlarged cross-sectional view showing a joined state in the vicinity of an outer peripheral portion of the integrally molded body shown in FIG. 19.

FIG. 21 is a schematic perspective view of an integrally molded body shown in Example 3.

FIG. 22 is a schematic view of a press mold used in Example 3.

FIG. 23 is a schematic view of an injection mold used in Example 3.

### DESCRIPTION OF REFERENCE SIGNS

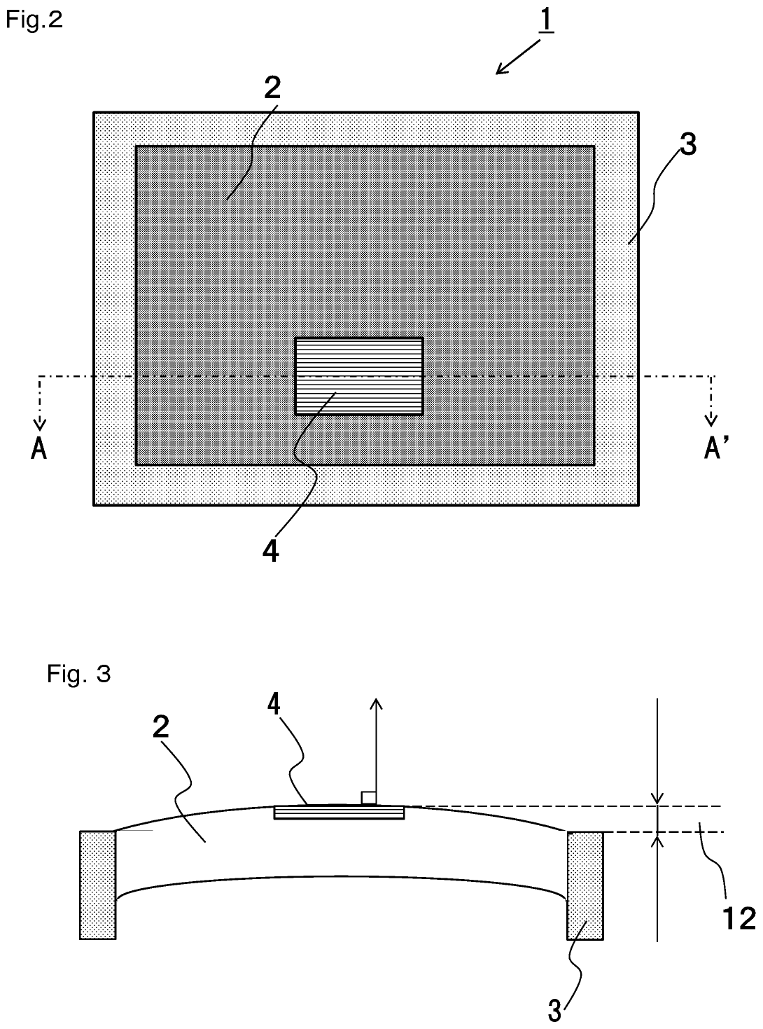

1: Integrally molded body
2: Laminate (A)
3: Resin member (B)
4: Flat portion (E) of convex shape formed on laminate (A)
5: Convex shape provided on lower plate surface of press mold at A-A′ cross-sectional position shown in FIG. 2
6: Shape of upper plate surface of press mold at A-A′ cross-sectional position shown in FIG. 2
7: Shape of upper plate surface of injection mold at A-A′ cross-sectional position shown in FIG. 2
8: Shape of lower plate surface of injection mold at A-A′ cross-sectional position shown in FIG. 2
10: Surface layer
11: Core layer
12: Distance T from plane of flat portion (E) to resin member (B) in perpendicular direction
13: Another member
14: First joint portion
15: Region other than first joint portion
16: Stepped portion
17: Thermoplastic resin layer (D)
18: Lower plate surface of press mold at A-A′ cross-sectional position shown in FIG. 16
19: Upper plate surface of press mold at A-A′ cross-sectional position shown in FIG. 16
20: Lower plate surface of injection mold at A-A′ cross-sectional position shown in FIG. 16
21: Upper plate surface of injection mold at A-A′ cross-sectional position shown in FIG. 16
22: Convex shape provided on lower plate surface of press mold at A-A′ cross-sectional position shown in FIG. 2
23: Shape of upper plate surface of press mold at A-A′ cross-sectional position shown in FIG. 2
24: Shape of lower plate surface of press mold at A-A′ cross-sectional position shown in FIG. 2
25: Shape of upper plate surface of injection mold at A-A′ cross-sectional position shown in FIG. 2
26: Shape of lower plate surface of injection mold at A-A′ cross-sectional position shown in FIG. 2
27: R shape provided on lower plate surface of injection mold at A-A′ cross-sectional position shown in FIG. 2

### DETAILED DESCRIPTION

Hereinafter, an example will be described with reference to the Drawings. Our molded bodies are limited to neither the drawings nor working examples.

An integrally molded body (C) is an integrally molded body (C) including:
a laminate (A) having a design surface on one side; and
a resin member (B) that is joined to an outer peripheral side surface of the laminate (A) and that contains discontinuous fibers and a thermoplastic resin, wherein
a convex portion protruding toward the design surface side is formed in a partial region of the laminate (A),
a flat portion (E) is provided at a maximum height position of the convex portion, and
a distance between an extension line extended from the flat portion (E) in an in-plane direction of the flat portion (E) and an intersection (F) at which a line moved from the extension line in a direction perpendicular to the flat portion (E) intersects the resin member (B) is 0.05 to 4.0 mm.

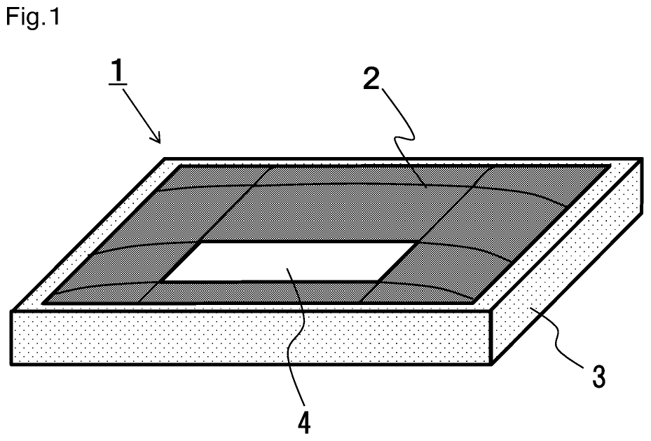

A perspective view, a plan view and an A-A′ schematic cross-sectional view of an integrally molded body (C) according to an example are shown in FIGS. 1, 2 and 3, respectively.

The integrally molded body (C) 1 shown in these drawings has a configuration in which a resin member (B) 3 is joined to a laminate (A) 2. The integrally molded body (C) 1 has, in a partial region of the laminate (A), a convex portion where the design surface side protrudes convexly, and a flat portion (E) 4 at a maximum height position of the convex portion. In the laminate (A) 2, a surface positioned at an upper side in FIGS. 1 and 3 is the design surface.

As shown in FIG. 3, by providing the convex portion so that the laminate (A) protrudes convexly on the design surface side, “resin rich” and voids are less likely to occur even when continuous fibers are used for the laminate (A), and high strength and high rigidity can be achieved. Therefore, it is possible to reduce the weight and thickness compared to known molded bodies and, for example, when such an integrally molded body is used for a housing of a personal computer or the like, it is possible to further prevent interference with internal components. The thickness of our integrally molded body can be reduced by providing the flat portion (E) 4 at the maximum height position of the convex portion.

Further, it is important that a distance T (mm) 12 between an extension line extended from the flat portion (E) 4 in the in-plane direction of the flat portion (E) 4 and an intersection (F) at which a line moved from the extension line in a direction perpendicular to the flat portion (E) 4 intersects the resin member (B) 3 is 0.05 to 4.0 mm. When the distance T (mm) 12 is less than 0.05 mm, the space (gap) in the in-plane direction is also reduced in addition to the space in the out-of-plane direction in the laminate, and interference with the internal components may occur. On the other hand, when the distance T (mm) 12 exceeds 4.0 mm, the interference with the internal components does not occur, but the convex shape is conspicuous when viewed from the appearance surface, which may be disadvantageous in the appearance surface. A more preferable range of the distance T (mm) 12 is 2.0 to 4.0 mm from the viewpoint of securing the internal component insertion space, and more preferably 2.0 to 3.0 mm from the viewpoint of securing the internal component insertion space and the viewpoint of the appearance.

The flat portion (E) existing at the maximum height position of the convex portion of the integrally molded body is sufficient if it has a substantially flat shape. That is, the flat shape also includes a shape having a very gentle curved shape, in addition to a shape that becomes a straight line in a transverse cross section. When R is a radius of curvature thereof, a portion having R of 600 mm or more is regarded as a flat portion. When the radius of curvature is too small, the total thickness of the electronic device becomes large, and the advantage of thin thickness is lost. Therefore, the radius of curvature is preferably R 800 mm or more, or R 1,000 mm or more.

The flat portion (E) may be disposed at the center of the laminate (A) or may be disposed at a position shifted from the center. However, when the flat portion (E) is disposed at a position shifted from the center of the laminate (A), the convex portion has an asymmetric shape, and the gradient of a part of the protruding curve also abruptly changes. Therefore, R of the protruding curve toward the flat portion (E) is preferably 50 mm or more over the entire region. When R of the protruding curve is less than 50 mm over the entire surface, a streak-like appearance defect is likely to occur in the appearance. From the viewpoint of appearance, R of the bent portion is preferably R 150 mm or more, and more preferably R 300 mm or more.

The resin member (B) 3 is preferably joined to and formed over the entire periphery of the outer peripheral side surface of the laminate (A) 2. By forming a joint portion with the resin member (B) 3 over the entire periphery of the outer peripheral side surface of the laminate (A) 2, high joining strength and thickness reduction can be realized as the entire integrally molded body 1.

From the viewpoint of reducing warpage of the integrally molded body (C), the resin member (B) 3 needs to contain reinforcing fibers, and the reinforcing fibers need to be discontinuous fibers. The discontinuous fibers preferably have a weight average fiber length of 0.3 to 3 mm. As a method of measuring the fiber length of the discontinuous fibers, for example, there is a method of directly extracting the discontinuous fibers from the integrally molded body (C) and measuring the fiber length by microscopic observation. When resin is attached to the discontinuous fibers, the resin is dissolved from the discontinuous fibers in a solvent that dissolves only the resin attached to the discontinuous fibers, and the remaining discontinuous fibers are separated by filtration and measured by microscopic observation (dissolution method), for example. When there is no solvent that dissolves the resin, only the resin is burned off in a temperature range in which the discontinuous fibers are not oxidized and reduced, to thereby separate the discontinuous fibers, and the separated fibers are measured by microscopic observation (burning off method), for example. Four hundred discontinuous fibers are randomly selected, and the lengths thereof are measured in the order of 1 μm with an optical microscope, and then the fiber length and the proportion thereof may be obtained.

Continuous fibers and discontinuous fibers are defined. The continuous fibers refer to a state in which the reinforcing fibers contained in the integrally molded body (C) 1 are arranged substantially continuously over the entire length or the entire width of the integrally molded body (C) 1. The discontinuous fibers refer to a state in which the reinforcing fibers are intermittently divided. In general, fibers used as a unidirectional fiber-reinforced resin in which reinforcing fibers arranged in one direction are impregnated with a resin correspond to continuous fibers. Reinforcing fibers contained in a base material of SMC (sheet molding compound) used for press molding, a pellet material used for injection molding and the like correspond to discontinuous fibers.

The weight fiber content of the discontinuous fibers contained in the resin member (B) 3 is preferably 1 to 60 wt %. As a result, the joining strength with the laminate (A) 2 can be increased, and the warpage of the integrally molded body (C) 1 can be reduced. When the weight fiber content is less than 1 wt %, it may be difficult to secure the strength of the molded body 1, and when the weight fiber content is more than 60 wt %, filling of the resin member (B) 3 in injection molding may be partially insufficient. From the viewpoint of moldability of the resin member (B) 3, the weight fiber content is prefer-ably 5 to 55 wt %, more preferably 8 to 50 wt %, and still more preferably 12 to 45 wt %.

The laminate (A) 2 includes surface layers and a core layer, and has a sandwich structure in which the core layer is sandwiched between the surface layers. With this configuration, lightness can be enhanced while maintaining strength and rigidity. The surface layer is composed of a fiber-reinforced resin member containing continuous reinforcing fibers and a resin, and the core layer is any one selected from a film, a foam, and a porous base material. The specific gravity of the laminate (A) 2 is preferably 0.5 to 1.4 from the viewpoint of weight reduction.

The film constituting the core layer is preferably a thermoplastic resin film, and the porous base material is preferably a porous base material containing discontinuous fibers, and a thermoplastic resin or a thermosetting resin.

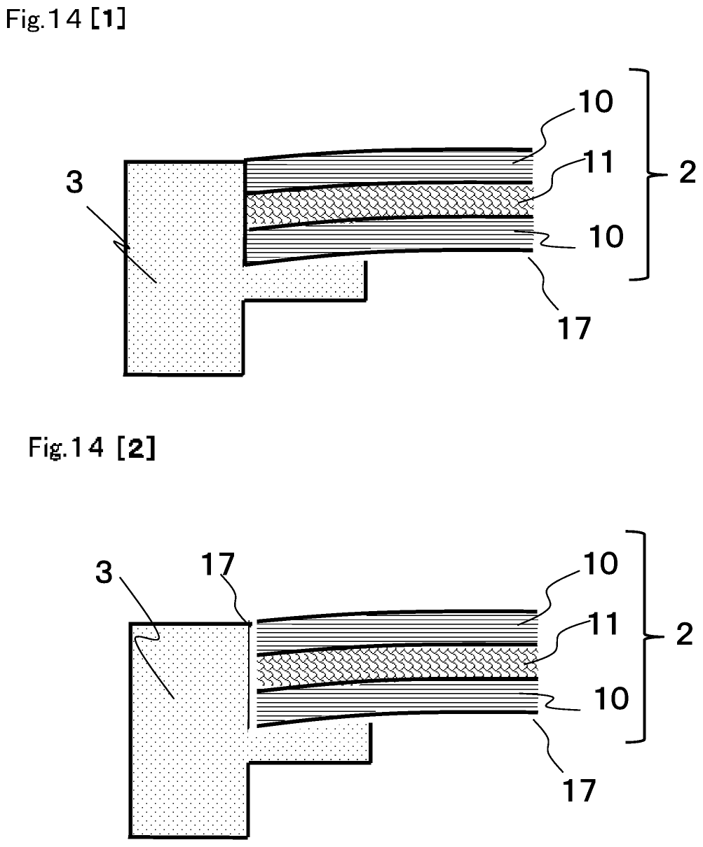

From the viewpoint of high strength and high rigidity, it is also preferable to further provide a thermoplastic resin layer (D) on the outer surface opposite to the design surface of the laminate (A) 2 (that is, the non-design surface), and to bond and join the laminate (A) 2 and the resin member (B) 3 to each other with the thermoplastic resin layer (D) 17 interposed therebetween as shown in FIGS. 14[1] and 14[2].

Examples of the reinforcing fibers contained in the laminate (A) 2 and the resin member (B) 3 include inorganic fibers such as metal fibers (for example, aluminum fibers, brass fibers, and stainless fibers), polyacrylonitrile-based, rayon-based, lignin-based, or pitch-based carbon fibers and graphite fibers, glass fibers, silicon carbide fibers, silicon nitride fibers, alumina fibers, silicon carbide fibers, and boron fibers; and organic fibers such as aramid fibers, polyparaphenylene benzobisoxazole (PBO) fibers, polyphenylene sulfide fibers, polyester fibers, acrylic fibers, nylon fibers, and polyethylene fibers. These reinforcing fibers may be used singly or in combination of two or more thereof.

As the reinforcing fibers used in the laminate (A) 2, carbon fibers are preferred from the viewpoint of specific strength, specific rigidity and lightness, and carbon fibers (including graphite fibers) excellent in specific strength and specific rigidity such as polyacrylonitrile (PAN)-based carbon fibers, rayon-based carbon fibers, lignin-based carbon fibers, and pitch-based carbon fibers are preferably used. Polyacrylonitrile (PAN)-based carbon fibers are preferable from the viewpoint of cost and processability.

The reinforcing fibers used for the resin member (B) 3 are preferably carbon fibers and glass fibers from the viewpoint of the strength of the resin member (B) 3. The reinforcing fibers used for the resin member (B) 3 are more preferably glass fibers, and a function as a radio wave transmission member can be imparted to the resin member (B) 3 by using glass fibers.

The resin member (B) 3 also contains a thermoplastic resin. When the laminate (A) 2 has the thermoplastic resin layer (D) on the non-design surface as described above, a joint structure is formed in which the thermoplastic resin of the resin member (B) 3 is melted and fixed to the thermoplastic resin of the thermoplastic resin layer (D). As a result, higher joining strength can be realized as the integrally molded body (C) 1. The melted and fixed joint structure means a joint structure in a state in which the members are melted by heat, cooled and fixed.

When carbon fibers are used as reinforcing fibers constituting the laminate (A) 2, the density of the fibers is preferably 1.6 g/cm³ or more and 2.0 g/cm³ or less in polyacrylonitrile (PAN)-based carbon fibers, 1.8 g/cm³ or more and 2.0 g/cm³ or less from the viewpoint of improving rigidity, 2.0 g/cm³ or more and 2.5 g/cm³ or less in pitch-based carbon fibers, and 2.0 g/cm³ or more and 2.3 g/cm³ or less from the viewpoint of cost. Polyacrylonitrile (PAN)-based carbon fibers having excellent processability are preferable.

When carbon fibers are used as reinforcing fibers constituting the laminate (A) 2, preferably, carbon fibers having a tensile modulus of 200 to 1,000 GPa can be used from the viewpoint of the rigidity of the sandwich structure, and more preferably, carbon fibers having a tensile modulus of 400 to 900 GPa can be used from the viewpoint of the handleability of the prepreg. When the tensile modulus of the carbon fibers is less than 200 GPa, the rigidity of the sandwich structure may be poor, and when the tensile modulus of the carbon fibers is more than 1,000 GPa, it is necessary to enhance the crystallinity of the carbon fibers, which makes it difficult to produce carbon fibers. When the tensile modulus of the carbon fibers is within the above range, it is preferable from the viewpoint of further improving the rigidity of the sandwich structure and improving the productivity of carbon fibers. The tensile modulus of the carbon fibers can be measured by a strand tensile test described in JIS R7301-1986.

Further, the laminate (A) 2 has a sandwich structure including surface layers and a core layer in a layered manner as described above, but each of the surface layers containing continuous reinforcing fibers and a resin preferably has a lamination structure of two or more layers. The lamination structure in each surface layer can be freely set, and layers of each surface layer can be freely laminated from the viewpoint of desired rigidity, thickness, strength and the like. The thickness of the surface layer and each layer (skin layer) constituting the surface layer is preferably 0.05 to 1.00 mm from the viewpoint of the thickness of the laminate (A). More preferably, the thickness is 0.05 to 0.20 mm from the viewpoint of the degree of freedom in lamination design.

By forming the laminate (A) 2 into a sandwich structure, the surface layer and each layer (skin layer) constituting the surface layer easily conform to the shape of the convex portion protruding toward the design surface side in a partial region of the laminate (A) 2. Since the surface layer and each layer (skin layer) constituting the surface layer easily conform to the convex shape, fiber breakage and opening of the continuous fibers can be suppressed, and occurrence of sink marks in the resin is prevented, thus yielding an integrally molded body having high designability. When the continuous fibers are in the form of a unidirectional fiber or a woven fabric, the distance between adjacent continuous fibers is preferably kept less than 2 mm, and more preferably kept less than 1 mm. The distance between the adjacent continuous fibers is ideally 0 mm in some instances, but in reality, the distance is 0.01 mm or more particularly between fiber bundles, and 0.1 mm or more depending on the fiber type or the like in many instances. When adjacent fibers cannot be said to be parallel to each other, the distance can be determined by defining the longitudinal direction of any fiber as a reference direction, and measuring a distance between adjacent fibers in a direction perpendicular to the reference direction. When the integrally molded body has a rectangular planar shape and the fibers are arranged along either the longitudinal side or the lateral side of the molded body, the direction of either the longitudinal side or the lateral side of the molded body can be set as the reference direction.

A fiber woven fabric material can also be used for the surface layer of the laminate (A) 2. The fiber woven fabric material is a base material in which a continuous reinforcing fiber bundle in which 1,000 continuous reinforcing fibers are bundled together is used as a warp and a weft, and two sets of yarns are interlaced at a substantially right angle using a loom. In general, a continuous reinforcing fiber bundle including 1,000 fibers is referred to as 1 K, a continuous reinforcing fiber bundle including 3,000 fibers is referred to as 3 K, and a continuous reinforcing fiber bundle including 12,000 fibers are referred to as 12 K.

Examples of the fibers used for the fiber woven fabric material include metal fibers such as aluminum fibers, brass fibers, and stainless fibers, glass fibers, polyacrylonitrile-based, rayon-based, lignin-based, or pitch-based carbon fibers and graphite fibers, organic fibers such as aromatic polyamide fibers, polyaramid fibers, PBO fibers, polyphenylene sulfide fibers, polyester fibers, acrylic fibers, nylon fibers, and polyethylene fibers, and silicon carbide fibers, silicon nitride fibers, alumina fibers, silicon carbide fibers, and boron fibers. These are used alone or in combination of two or more.

These fiber materials may be subjected to surface treatment. Examples of the surface treatment include a metal deposition treatment, a treatment with a coupling agent, a treatment with a sizing agent, and an additive attachment treatment.

When carbon fibers are used as the fiber woven fabric material, carbon fibers (including graphite fibers) excellent in specific strength and specific rigidity such as polyacrylonitrile (PAN)-based carbon fibers, rayon-based carbon fibers, lignin-based carbon fibers and pitch-based carbon fibers are preferably used from the viewpoint of the weight reduction effect. Among them, PAN-based carbon fibers having excellent processability are desirable.

The fiber woven fabric material is preferably at least one fabric selected from plain weave, twill weave, satin weave, and satin weave. Since the fiber woven fabric material is characterized by a fiber pattern, an integrally molded body exhibiting a novel surface pattern can be obtained by using the fiber woven fabric material in which the characteristic fiber pattern is emphasized, as the outermost layer (design surface side) of the laminate (A) 2. The continuous reinforcing fiber bundle is preferably 1 K to 24 K, and more preferably 1 K to 6 K from the viewpoint of the stability of the fiber pattern during processing.

When the fiber woven fabric material is used for the surface layer of the laminate, the core layer serves as a cushion, and it is possible to reduce a spot called “pit” where the resin lacks at the intersection of the warp and the weft. The “pit” is preferably less than 0.4 mm², and more preferably 0.2 mm².

In addition, the type of the thermoplastic resin constituting the surface layer of the laminate (A) 2, the resin member (B) 3, the porous base material which is one type of core layer included in the laminate (A) 2, and the thermoplastic resin layer (D) is not particularly limited, and any of the thermoplastic resins exemplified below can be used. Examples of the thermoplastic resin include polyester resins such as a polyethylene terephthalate (PET) resin, a polybutylene terephthalate (PBT) resin, a polytrimethylene terephthalate (PTT) resin, a polyethylene naphthalate (PEN resin), and a liquid crystal polyester resin: polyolefin resins such as polyethylene (PE resin), polypropylene (PP resin), and a polybutylene resin: polyarylene sulfide resins such as a polyoxymethylene (POM) resin, a polyamide (PA) resin, and a polyphenylene sulfide (PPS) resin; fluorine-based resins such as a polyketone (PK) resin, a polyether ketone (PEK) resin, a polyether ether ketone (PEEK) resin, a polyether ketone (PEKK) resin, a polyether nitrile (PEN) resin, and a polytetrafluoroethylene resin: crystalline resins such as a liquid crystal polymer (LCP): amorphous resins such as, in addition to a styrene-based resin, a polycarbonate (PC) resin, a polymethyl methacrylate (PMMA) resin, a polyvinyl chloride (PVC) resin, a polyphenylene ether (PPE) resin, a polyimide (PI) resin, a polyamideimide (PAI) resin, a polyetherimide (PEI) resin, a polysulfone (PSU) resin, a polyethersulfone resin, and a polyarylate (PAR) resin: thermoplastic elastomers such as a phenol-based resin, a phenoxy resin, a polystyrene-based resin, a polyurethane-based resin, a polybutadiene-based resin, a polyisoprene-based resin, and an acrylonitrile-based resin; and thermoplastic resins selected from copolymers and modified products thereof.

Among these, polyolefin resin is preferable from the viewpoint of lightness of the molded article obtained, polyamide resin is preferable from the viewpoint of strength, amorphous resins such as polycarbonate resin, styrene-based resin, and modified polyphenylene ether-based resin are preferable from the viewpoint of surface appearance, polyarylene sulfide resin is preferable from the viewpoint of heat resistance, and polyetheretherketone resin is preferably used from the viewpoint of continuous use temperature.

The exemplified thermoplastic resins may contain an impact resistance improver such as elastomer or a rubber component, another filler, or additive as long as the desired object is not impaired. Examples of them include an inorganic filler, a flame retardant, a conductivity imparting agent, a crystal nucleating agent, an ultraviolet absorber, antioxidant, a vibration suppressing agent, an antibacterial agent, an insect repellent, a deodorant, a coloring inhibitor, a heat stabilizer, a release agent, an antistatic agent, a plasticizer, lubricant, a colorant, a pigment, a dye, a foaming agent, a defoaming agent, and a coupling agent.

As the thermosetting resin constituting the surface layer of the laminate (A) 2, a thermosetting resin such as an unsaturated polyester resin, a vinyl ester resin, an epoxy resin, a phenol (resol type) resin, a urea-melamine resin, a polyimide resin, a maleimide resin, or a benzoxazine resin can be preferably used. Two or more of these may be blended and applied. Among them, an epoxy resin is particularly preferable from the viewpoint of mechanical properties and heat resistance of the molded body. The epoxy resin is preferably contained as a main component of the resin to be used to exhibit its excellent mechanical properties. Specifically, the epoxy resin is preferably contained in an amount of 60 wt % or more per resin composition.

As the foam having pores which is used for the core layer of the laminate (A) 2, a polyurethane resin, a phenol resin, a melamine resin, an acrylic resin, a polyethylene resin, a polypropylene resin, a polyvinyl chloride resin, a polystyrene resin, an acrylonitrile-butadiene-styrene (ABS) resin, a polyetherimide resin, or a polymethacrylimide resin can be suitably used. Specifically, to ensure lightness, it is preferable to use a resin having an apparent density smaller than that of the resin used for the surface layer. In particular, a polyurethane resin, an acrylic resin, a polyethylene resin, a polypropylene resin, a polyetherimide resin, or a polymethacrylimide resin can be preferably used. The exemplified resins may contain an impact resistance improver such as an elastomer or a rubber component, another filler, or additives as long as the desired object is not impaired. Examples of them include an inorganic filler, a flame retardant, a conductivity imparting agent, a crystal nucleating agent, an ultraviolet absorber, antioxidant, a vibration suppressing agent, an antibacterial agent, an insect repellent, a deodorant, a coloring inhibitor, a heat stabilizer, a release agent, an antistatic agent, a plasticizer, lubricant, a colorant, a pigment, a dye, a foaming agent, a defoaming agent, and a coupling agent.

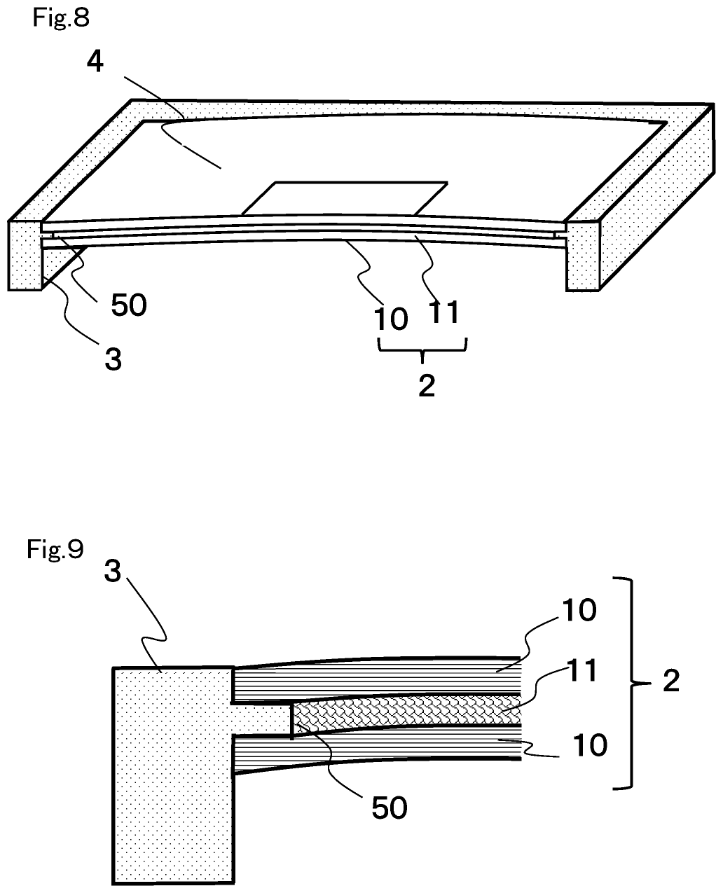

From the viewpoint of the joining strength of the integrally molded body (C) 1, it is preferable to have a configuration in which a fitting portion into which the resin member (B) 3 enters is provided in a part of the core layer composed of any of a film, a foam, and a porous base material. Such a fitting portion may be provided over the entire outer periphery of the laminate (A), but may be provided at least part of the laminate (A). FIGS. 8 and 9 show aspects thereof.

In the aspects shown in FIGS. 8 and 9, fitting portions 50 are provided on three sides of the rectangular laminate (A) 2 including surface layers 10 and a core layer 11. By providing the fitting portion 50, when the resin member (B) 3 is injection-molded in the production process of the laminate (A) 2, the resin member (B) 3 enters a partial region of the core layer 11 from the side surface portion of the laminate (A) 2 by injection molding pressure. As a result, the resin member (B) 3 and the planar portion and the side surface portion of the surface layer 10 of the laminate (A) 2 are joined. This is because the region in the core layer 11 has a high porosity, and thus has a structure in which the molten resin of the resin member (B) 3 easily penetrates. At this time, by using a porous base material containing discontinuous fibers and a thermoplastic resin for the core layer 11, the joining strength can be further enhanced with the anchor effect obtained by the resin member (B) 3 entering the inside of the core layer 11.

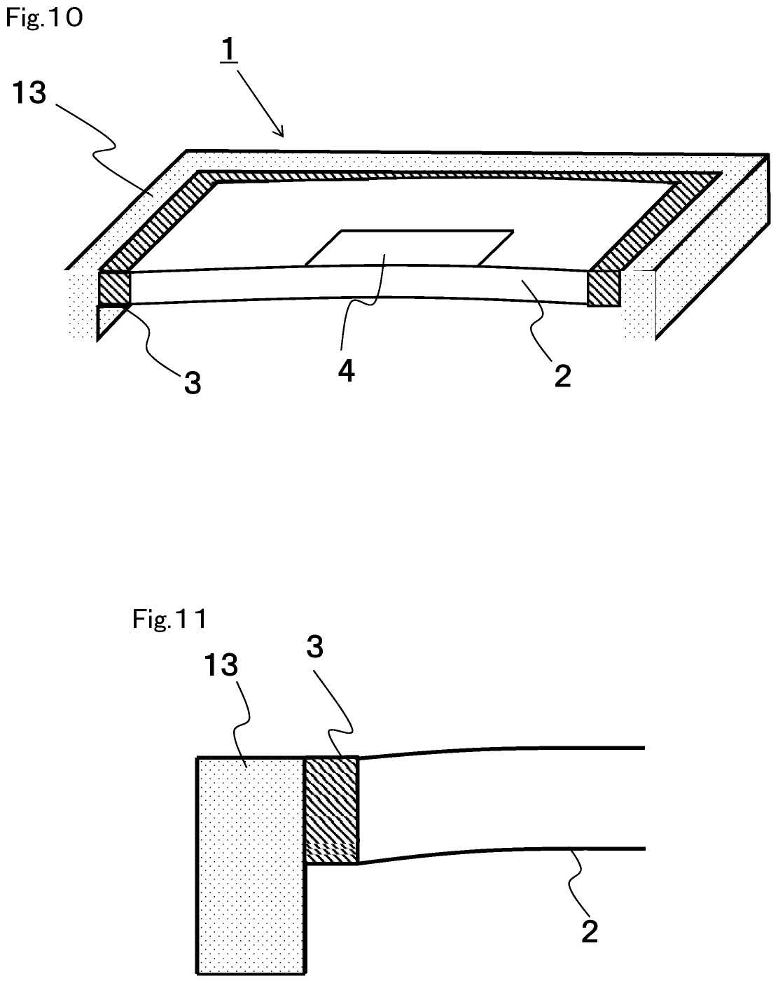

As shown in FIGS. 10 and 11, it is also preferable that before the resin member (B) 3 is injected, another member 13 is provided in the outer peripheral portion of the laminate (A) 2 in advance, and then the resin member (B) 3 is injection-molded. This is an effective means of achieving reduction in warpage of the integral molding (C) 1.

As another member 13, a fiber-reinforced resin frame made of reinforcing fibers and a resin is preferable from the viewpoint of strength and rigidity of the integrally molded body. As the reinforcing fibers constituting another member 13, reinforcing fibers used in the resin member (B) 3 described above can be used. Glass fibers and carbon fibers are preferable from the viewpoint of increasing the strength of another member 13, and glass fibers are preferably used from the viewpoint of antenna performance. On the other hand, although carbon fibers are inferior to glass fibers in antenna performance, carbon fibers can be usefully used for the purpose of improving strength and rigidity.

The total thickness of the laminate (A) 2 is preferably 0.3 mm to 2.0 mm. When the total thickness is less than 0.3 mm, the rigidity as the integrally molded body (C) 1 tends to be insufficient. When the total thickness exceeds 2.0 mm, lightness may be impaired. The total thickness is more preferably 0.7 mm to 1.5 mm from the viewpoint of lightness and rigidity. The total thickness is a value measured at the thickest portion of the laminate (A).

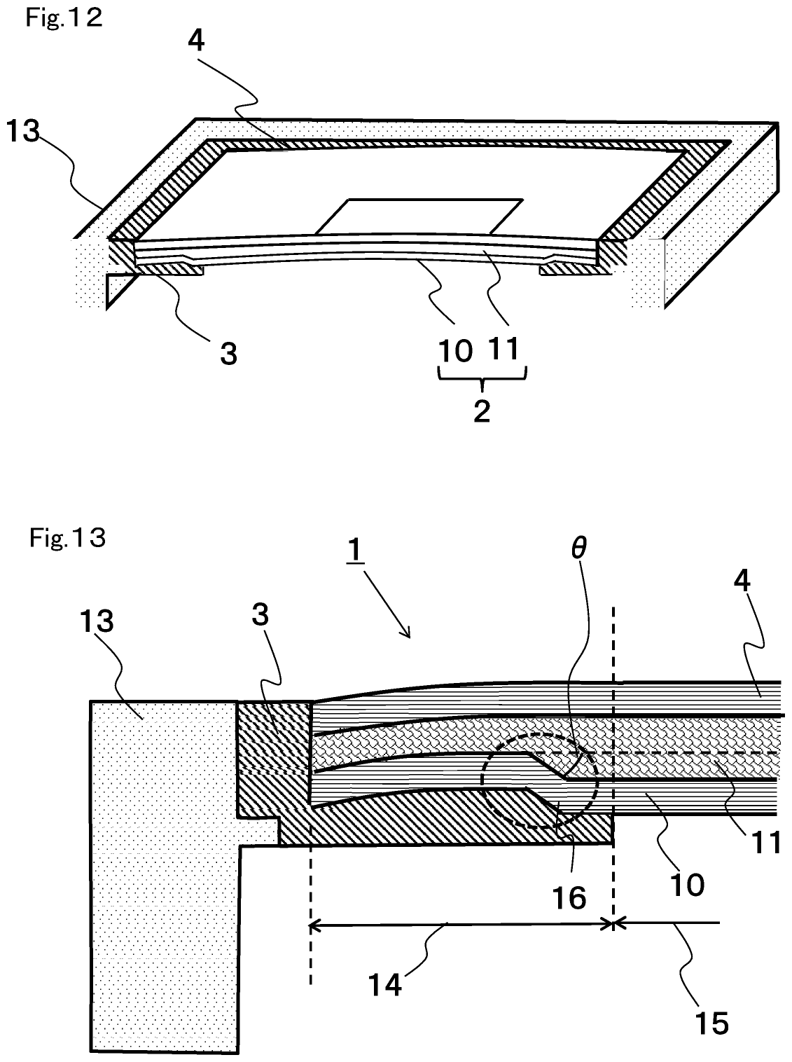

As shown in FIGS. 12 and 13, it is preferable that the laminate (A) 2 and the resin member (B) 3 are joined not only at the outer peripheral side surface of the laminate (A) 2 but also at the outer peripheral portion of the surface opposite to the design surface of the laminate (A) (non-design surface). At this time, assuming that a joint portion with the resin member (B) 3 on the non-design surface of the laminate (A) 2 is referred to as a “first joint portion,” it is preferable that the laminate (A) 2 has a stepped portion 16 in a range of the “first joint portion” in the in-plane direction, and the stepped portion 16 has an inclined surface having an angle θ with respect to the in-plane direction of the flat portion (E) provided in the laminate (A) 2. Specifically, for example, it is preferable that a region substantially horizontal to the in-plane direction of the main body but having a different thickness is provided in the first joint portion 14 at the outer peripheral portion in the in-plane direction of the laminate (A) 2, and the surface layer 10 on the lower side (the non-design surface side of the laminate (A) 2) has a stepped portion 16 having an inclination of an angle θ. As a result, the joining area of the first joint portion 14 can be increased compared to when another structure is simply joined to the flat portion on the side surface of the sandwich structure so that the effect of increasing the joining strength can be obtained.

The angle θ(°) of the inclined surface of the stepped portion 16 with respect to the in-plane direction of the flat portion (E) provided in the laminate (A) 2 is preferably 10 to 80°, more preferably 10 to 50°, and still more preferably 10 to 20° from the viewpoint of the moldability of the laminate (A) 2.

The in-plane direction of the flat portion (E) as a reference of the angle θ of the inclined surface is defined as a linear direction when the flat portion (E) has a linear shape in the cross section. On the other hand, when the flat portion (E) has the radius of curvature as described above in the cross section, the in-plane direction is defined as a linear direction connecting the ends of the region of R 600 mm (the smallest value in the radius regarded as the flat portion) or more.

When the core layer 11 is composed of a porous base material containing discontinuous fibers and a thermoplastic resin/thermosetting resin, the following configuration is preferable from the viewpoint of the rigidity of the integrally molded body (C) 1. That is, it is preferable that the porosity of the core layer 11 at the first joint portion 14 and the porosity of the core layer 11 at a region other than the first joint portion 15 are different and, further, it is preferable that the porosity of the porous base material at the first joint portion 14 is lower than the porosity of the porous base material at the region other than the first joint portion 15.

Further, when the laminate (A) 2 has a rectangular shape in a top view, the region of the resin member (B) 3 is reduced. As a result, the warpage of the integral molding (C) 1 can be reduced.

### EXAMPLES

Hereinafter, the integrally molded body (C) will be specifically described with reference to Examples, but the following Examples do not limit this disclosure. The measurement method used in Examples will be described below.

### (1) Flatness Measurement of Integrally Molded Body

The height (mm) in the thickness direction of the top plate (laminate (A) 2) and the height (mm) of the resin member (B) 3 were measured as follows using a three-dimensional measuring instrument with the design surface side of the integrally molded body having a box shape facing upward. The measurement points are the following two points: the flat portion (E) 4 provided at the maximum height position of the convex shape formed on the top plate (laminate (A) 2); and an intersection (F) at which a line which is moved in a direction perpendicular to the flat portion (E) 4 from an extension line extended in the in-plane direction of the flat portion (E) 4 intersects the resin member (B) 3. Further, the obtained values were evaluated according to the following criteria. A is acceptable and B and C are unacceptable.
A: The distance (T) between the flat portion (E) 4 and the intersection (F) is within a range of 0.05 to 4.0 mm, and there is no occurrence of appearance defects such as blur, fiber breakage, opening, and pits regarding the appearance on the design surface side of the laminate (A) 2.
B: The distance (T) between the flat portion (E) 4 and the intersection (F) is out of the range of 0.05 to 4.0 mm, and there is no occurrence of appearance defects such as blur, fiber breakage, opening, and pits regarding the appearance on the design surface side of the laminate (A) 2.
B′: The distance (T) between the flat portion (E) 4 and the intersection (F) is within the range of 0.05 to 4.0 mm, and when the laminate (A) 2 is observed from the design surface side, the laminate (A) 2 has appearance defects such as sink marks, fiber breakage, opening, and pits.
C: The distance (T) between the flat portion (E) 4 and the intersection (F) is out of the range of 0.05 to 4.0 mm, and when the laminate (A) 2 is observed from the design surface side, the laminate (A) 2 has appearance defects such as sink marks, fiber breakage, opening, and pits.

### Material Composition Example 1 PAN-Based Unidirectional Prepreg

A PAN-based prepreg (“TORAYCA” (registered trademark) manufactured by Toray Industries, Inc., product name: P3252S-15, thickness: 0.14 mm) was used.

### Material Composition Example 2 Thermoplastic Film

A polyester resin film having a thickness of 0.05 mm was obtained using a polyester resin (“Hytrel” (registered trademark) manufactured by Du Pont-Toray Co., Ltd.). This was used as a thermoplastic film (thermoplastic adhesive film).

### Material Composition Example 3 Glass Fiber-Reinforced Polycarbonate Resin

Glass fiber-reinforced polycarbonate compound pellets (“Panlite” (registered trademark) GXV-3545WI (manufactured by Teijin Chemicals Ltd.)) were used.

### Material Composition Example 4 Chopped Carbon Fiber Bundle

PAN-based carbon fibers (“TORAYCA” (registered trademark) manufactured by Toray Industries, Inc., product name: T700SC) were cut with a cartridge cutter to obtain chopped carbon fiber bundles having a fiber length of 6 mm.

### Material Composition Example 5 Preparation of Carbon Fiber Mat

A 1.5 wt % aqueous solution (100 liters) of a surfactant (“sodium n-dodecylbenzene-sulfonate” (product name) manufactured by Wako Pure Chemical Industries, Ltd.) was stirred to prepare a pre-bubbled dispersion. The chopped carbon fiber bundles were put into the dispersion and stirred. The resulting mixture was poured into a paper machine having a paper surface having a length of 400 mm×a width of 400 mm, dehydrated by suction, and then dried at a temperature of 150° C. for 2 hours to obtain a carbon fiber mat. The obtained mat was in a good dispersion state.

### Material Composition Example 6 Adjustment of Polypropylene Resin Film

Dry blending was performed using 90 mass % of an unmodified polypropylene resin (“Prime Polypro” (registered trademark) J105G manufactured by Prime Polymer Co., Ltd., melting point: 160° C.) and 10 mass % of an acid-modified polypropylene resin (“ADMER” (registered trademark) QE510 manufactured by Mitsui Chemicals, Inc., melting point: 160° C.), and a polypropylene resin film was obtained using the dry blend resin.

### Material Composition Example 7 Foamed Resin Core

A non-cross-linked polypropylene sheet with low foaming ratio “EFCELL” (registered trademark) (foam magnification: two times) (manufactured by Furukawa Electric Co., Ltd.) was used.

### Material Composition Example 8 Carbon Fiber Core

Using Material Composition Example 5 and Material Composition Example 6, lamination was performed in the order of [polypropylene resin film/carbon fiber mat/polypropylene resin film].

### Material Composition Example 9 Carbon Fiber Woven Fabric Material

A PAN-based prepreg (“TORAYCA” (registered trademark) manufactured by Toray Industries, Inc., product name: F6343B-05P, thickness: 0.24 mm) was used.

### Comparative Example 1

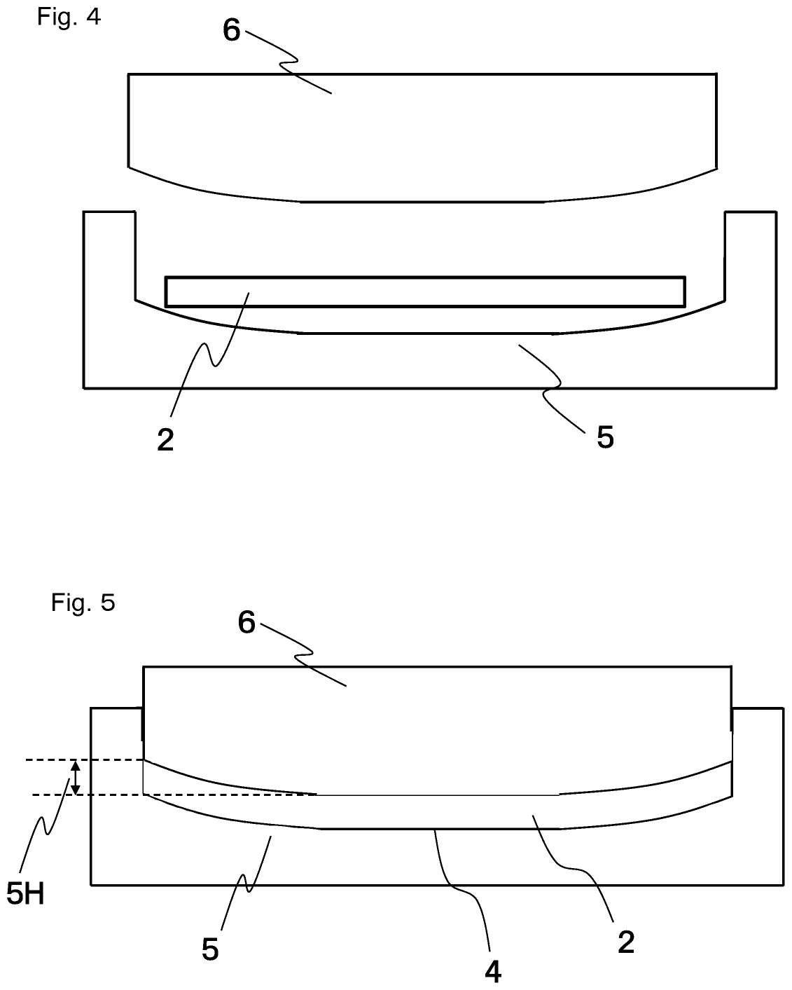

The PAN-based unidirectional prepreg obtained in Material Composition Example 1 and the thermoplastic adhesive film (D) obtained in Material Composition Example 2 were each adjusted to a size of 400 mm square, and then lamination was performed in the order of [PAN-based unidirectional prepreg 0°/PAN-based unidirectional prepreg 90°/PAN-based unidirectional prepreg 0°/PAN-based unidirectional prepreg 90°/PAN-based unidirectional prepreg 90°/PAN-based unidirectional prepreg 0°/PAN-based unidirectional prepreg 90°/PAN-based unidirectional prepreg 0°/thermoplastic adhesive film]. This laminate was set in the mold shown in FIGS. 4 and 5. To provide the laminate with a convex shape, the mold was provided with a convex shape 5 having a maximum height 5H of 1.0 mm. To adjust the thickness, a spacer having a thickness of 1.15 mm was inserted into the mold. After the mold was placed on a plate surface having a plate surface temperature of 150° C., the plate surface was closed, and heat pressing was performed at 3 MPa. After a lapse of 5 minutes from the pressurization, the plate surface was opened to obtain a thermoset CFRP plate with a thermoplastic adhesive film (D), the thermoset CFRP plate having a thickness of 1.15 mm and a flat portion at the maximum height position of the convex portion. This was used as a laminate (A) 2 (not a sandwich structure) to which the thermoplastic film (D) was attached.

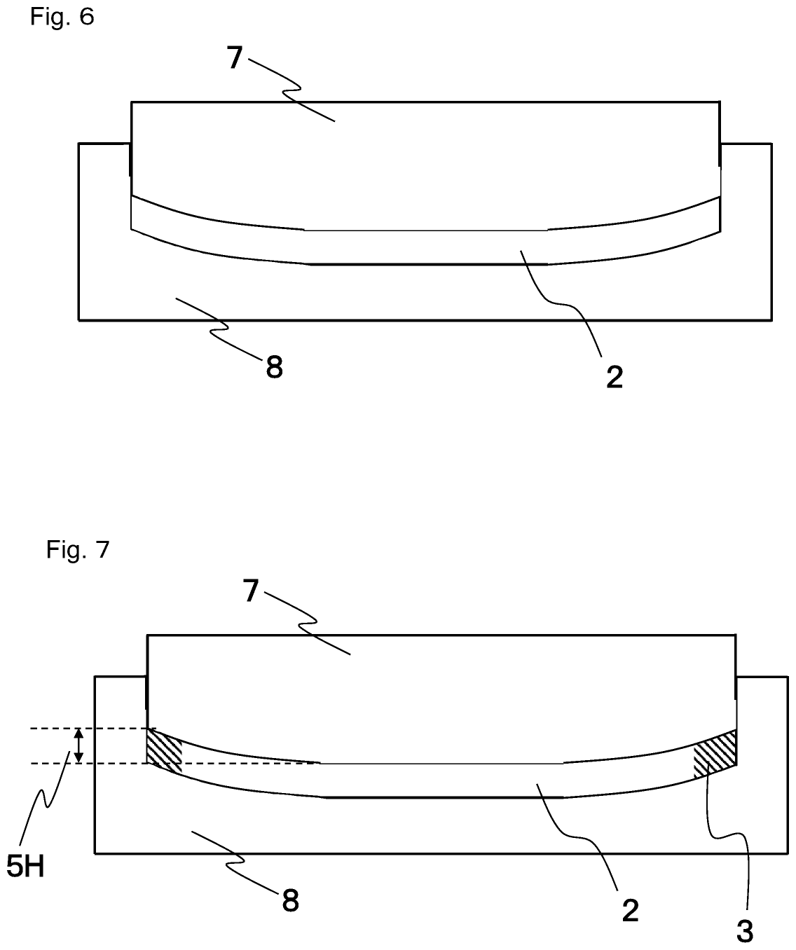

Next, the laminate (A) 2 with the thermoplastic film (D) was processed into a size of 300 mm×200 mm in a top view, and then the laminate was placed in the mold shown in FIG. 6 with the design surface side of the laminate facing the lower mold side. The upper mold was set, and the molds were clamped. Then, the glass fiber-reinforced polycarbonate resin of Material Composition Example 3 was injection-molded in the mold at 150 MPa, a cylinder temperature of 320° C., a mold temperature of 120° C., and a diameter of a resin discharge port of φ3 mm using an injection molding machine (not shown). Thus, an integrally molded body 1 including a top plate (laminate (A) 2) and a resin member (B) 3 shown in the schematic views of FIGS. 1 to 3 was produced.

The characteristics of the integrally molded body (C) 1 of Comparative Example 1 are collectively shown in Table 1. In the obtained integrally molded body (C) 1, a protruding convex shape was formed in a desired region of the laminate (A) 2, and a flat portion (E) was provided at the maximum height position of the convex portion. The flat portion (E) was completely flat, and a portion where the distance between continuous fibers was partially widened was generated on the design surface although there was no blur or breakage.

### Comparative Example 2

An integrally molded body was prepared in the same manner as in Comparative Example 1 except that the maximum height 5H of the convex shape of the mold was changed to 2.5 mm. The characteristics of the integrally molded body 1 are collectively shown in Table 1. In the obtained integrally molded body (C) 1, a protruding convex shape was formed in a desired region of the laminate (A) 2, and a flat portion (E) was provided at the maximum height position of the convex portion. The flat portion (E) was completely flat, and a portion where the distance between continuous fibers was partially widened was generated on the design surface although there was no blur or breakage.

### Comparative Example 3

An integrally molded body was prepared in the same manner as in Comparative Example 1 except that the maximum height 5H of the convex shape of the mold was changed to 3.0 mm. The characteristics of the integrally molded body 1 are collectively shown in Table 1. In the obtained integrally molded body (C) 1, a protruding convex shape was formed in a desired region of the laminate (A) 2, and a flat portion (E) was provided at the maximum height position of the convex portion. The flat portion (E) was completely flat, and a portion where the distance between continuous fibers was partially widened was generated on the design surface although there was no blur or breakage.

### Example 1

The PAN-based unidirectional prepreg obtained in Material Composition Example 1, the thermoplastic adhesive film (D) obtained in Material Composition Example 2, and Material Composition Example 8 were each adjusted to a size of 400 mm square, and then lamination was performed in the order of [PAN-based unidirectional prepreg 0°/PAN-based unidirectional prepreg 90°/polypropylene resin film/carbon fiber mat/polypropylene resin film/PAN-based unidirectional prepreg 90°/PAN-based unidirectional prepreg 0°/thermoplastic adhesive film] to have a sandwich structure. The laminate was sandwiched between release films, and this was placed on a heat-press mold having a plate surface temperature of 180° C. as shown in FIGS. 4 and 5. Then, the mold was closed, and heat pressing was performed at 3 MPa. After a lapse of 1 minute from the pressurization, the mold gap was widened by 1.15 mm only in a portion where the thickness of the core layer was increased as shown in FIG. 13. After a lapse of further 4 minutes, the mold was opened, and the molded article was quickly placed on the plate surface of a cold-press mold having a plate surface temperature of 40° C., and cold-pressed at 3 MPa. After 5 minutes, the molded article was taken out from the press mold to obtain a sandwich structure in which the plate thickness of the main body was 1.7 mm, the plate thickness of the thinnest portion of the joint portion (corresponding to the first joint portion) was 0.7 mm, and the angle θ of the inclined surface of the stepped portion was 15 degrees. The sandwich structure thus obtained was heated to 180° ° C. in a hot air oven, quickly placed on the plate surface of a cold-press mold having a plate surface temperature of 40° C., and cold-pressed at 3 MPa. To provide the laminate with a convex shape, the cold-press mold was provided with a convex shape 5 having a maximum height 5H of 1.0 mm in the same manner as in Comparative Example 1. To adjust the thickness, a spacer having a thickness of 1.15 mm was inserted into the mold. After 5 minutes, the molded article was taken out from the press mold to obtain a laminate (A) 2 in which the plate thickness of the main body was 1.15 mm and the plate thickness of the joint portion was 0.7 mm.

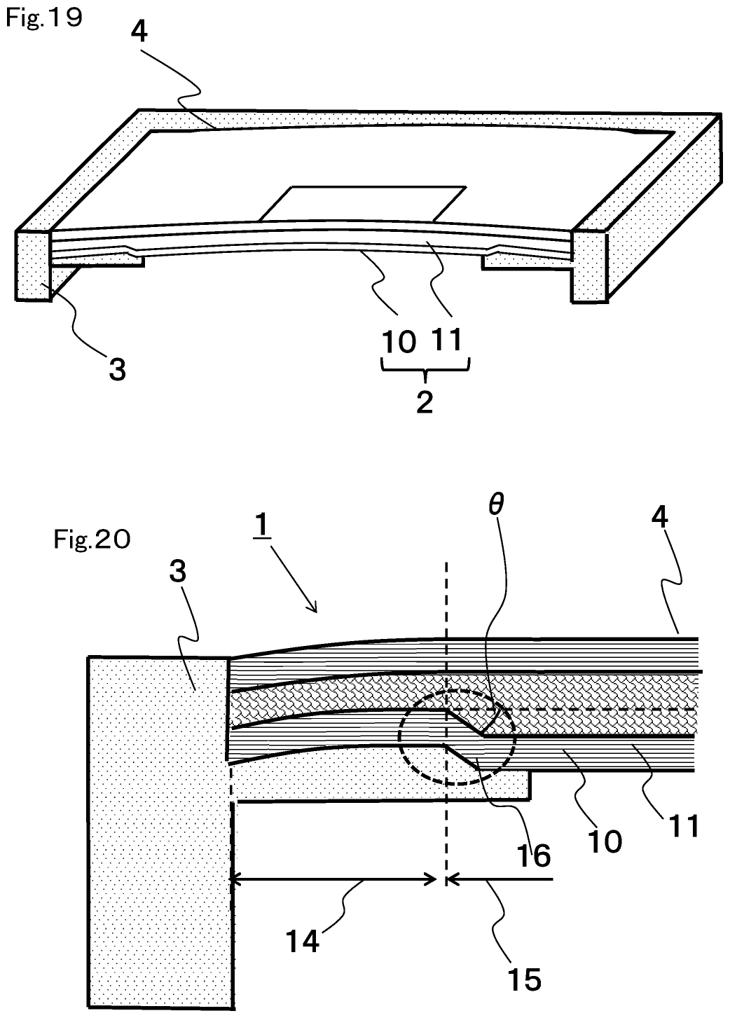

The laminate (A) 2 obtained above was set in the injection mold shown in FIGS. 6 and 7. After clamping, a glass fiber-reinforced polycarbonate resin (Material Composition Example 3) was injection-molded to produce the integrally molded body shown in the schematic views of FIGS. 19 and 20. The characteristics of the integrally molded body are collectively shown in Table 1.

In the obtained integrally molded body (C) 1, a protruding convex shape was formed in a desired region of the laminate (A) 2, and a flat portion (E) was provided at the maximum height position of the convex portion. The flat portion (E) was completely flat, and a molded article having a good appearance with high designability without appearance defects such as blur and fiber breakage on the design surface was obtained.

### Example 2

An integrally molded body was prepared in the same manner as in Comparative Example 1 except that the PAN-based unidirectional prepreg obtained in Material Composition Example 1, the thermoplastic adhesive film (D) obtained in Material Composition Example 2, and the foamed resin core of Material Composition Example 7 were each adjusted to a size of 400 mm square, and then lamination was performed in the order of [PAN-based unidirectional prepreg 0°/PAN-based unidirectional prepreg 90°/foamed resin core layer/PAN-based unidirectional prepreg 90°/PAN-based unidirectional prepreg 0°/thermoplastic adhesive film] to have a sandwich structure, and an integrally molded body 1 having a thickness of 1.15 mmt was obtained. The characteristics of the integrally molded body 1 are collectively shown in Table 1.

In the obtained integrally molded body (C) 1, a protruding convex shape was formed in a desired region of the laminate (A) 2, and a flat portion (E) was provided at the maximum height position of the convex portion. The flat portion (E) was completely flat, and a molded article having a good appearance with high designability without appearance defects such as blur and fiber breakage on the design surface was obtained.

### Example 3

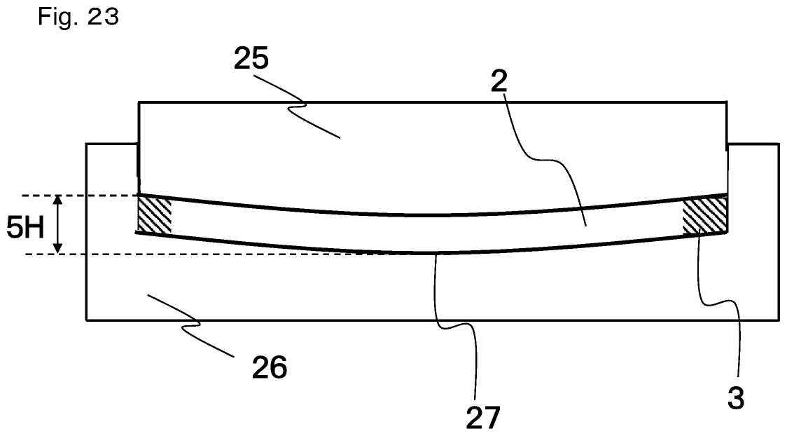

An integrally molded body was prepared in the same manner as in Example 2 except that the shape of the press mold was changed to that shown in FIG. 22 and the shape of the injection mold was changed to that shown in FIG. 23, and R of the flat portion (E) was 800 mm. The characteristics of the integrally molded body 1 are collectively shown in Table 1.

In the obtained integrally molded body (C) 1, a protruding convex shape was formed in a desired region of the laminate (A) 2, and a flat portion (E) was provided at the maximum height position of the convex portion. Although the flat portion (E) was formed in a moderate R shape, the flat portion (E) was substantially a flat portion (E), and a molded article having a good appearance with high designability without appearance defects such as blur and fiber breakage on the design surface was obtained.

### Example 4

An integrally molded body was prepared in the same manner as in Comparative Example 1 except that the PAN-based unidirectional prepreg obtained in Material Composition Example 1, the thermoplastic adhesive film (D) obtained in Material Composition Example 2, the carbon fiber woven fabric material of Material Composition Example 9, and the carbon fiber core of Material Composition Example 8 were each adjusted to a size of 400 mm square, and then lamination was performed in the order of [carbon fiber woven fabric material/PAN-based unidirectional prepreg 0°/PAN-based unidirectional prepreg 90°/carbon fiber core/PAN-based unidirectional prepreg 90°/PAN-based unidirectional prepreg 0°/thermoplastic adhesive film] to have a sandwich structure, and an integrally molded body 1 having a thickness of 1.15 mmt was obtained. The characteristics of the integrally molded body 1 are collectively shown in Table 1.

In the obtained integrally molded body (C) 1, a protruding convex shape was formed in a desired region of the laminate (A) 2, and a flat portion (E) was provided at the maximum height position of the convex portion. The flat portion (E) was completely flat, and a molded article having a good appearance with high designability without appearance defects such as blur, fiber breakage, opening, and “pits” on the design surface was obtained.

### Comparative Example 4

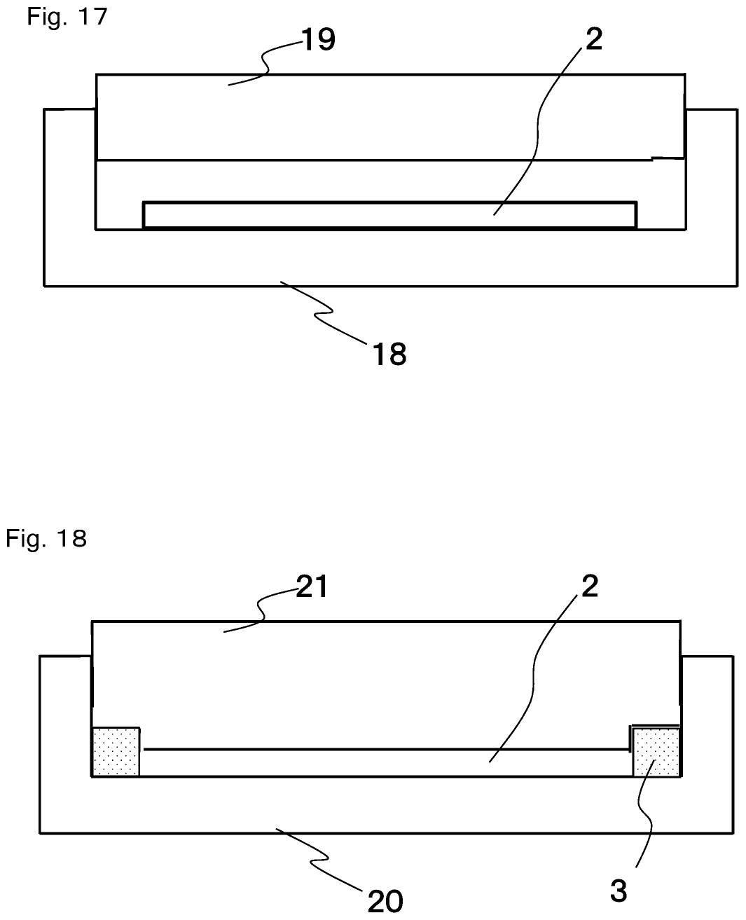

The PAN-based unidirectional prepreg obtained in Material Composition Example 1 and the thermoplastic adhesive film (D) obtained in Material Composition Example 2 were each adjusted to a size of 400 mm square, and then lamination was performed in the order of [PAN-based unidirectional prepreg 0°/PAN-based unidirectional prepreg 90°/PAN-based unidirectional prepreg 0°/PAN-based unidirectional prepreg 90°/PAN-based unidirectional prepreg 90°/PAN-based unidirectional prepreg 0°/PAN-based unidirectional prepreg 90°/PAN-based unidirectional prepreg 0°/thermoplastic adhesive film]. This laminate was set in the mold shown in FIG. 17. To adjust the thickness, a spacer having a thickness of 1.15 mm was inserted into the mold. After the mold was placed on a plate surface having a plate surface temperature of 150° C., the plate surface was closed, and heat pressing was performed at 3 MPa. After a lapse of 5 minutes from the pressurization, the plate surface was opened, and a thermoset CFRP plate with a thermoplastic adhesive film (D), the thermoset CFRP plate having a thickness of 1.15 mm was obtained. This was used as a laminate (A) 2 (not a sandwich structure) to which the thermoplastic film (D) was attached.

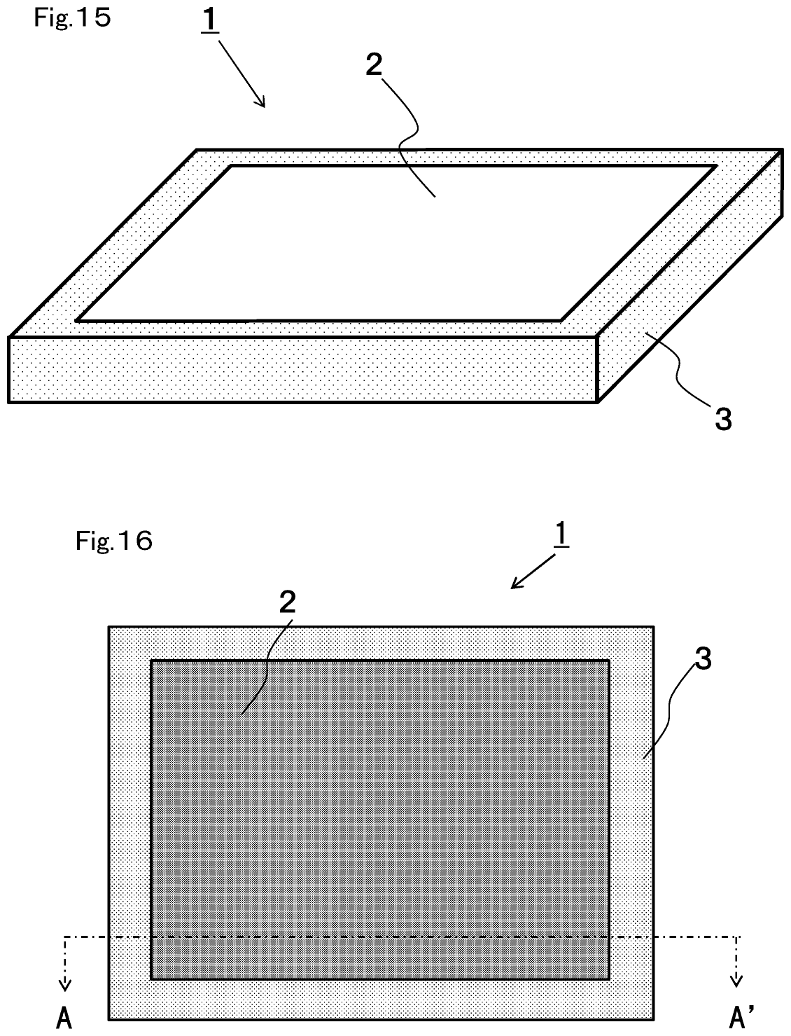

Next, the laminate (A) 2 with the thermoplastic film (D) was processed into a size of 300 mm×200 mm in a top view, and then the laminate was placed in the mold shown in FIG. 18 with the design surface side of the laminate facing the lower mold side. The upper mold was set, and the molds were clamped. Then, the glass fiber-reinforced polycarbonate resin of Material Composition Example 3 was injection-molded in the mold at 150 MPa, a cylinder temperature of 320° C., a mold temperature of 120° C., and a diameter of a resin discharge port of @ 3 mm using an injection molding machine (not shown). Thus, an integrally molded body 1 including a top plate (laminate (A) 2) and a resin member (B) 3 shown in the schematic views of FIGS. 15 and 16 was produced.

The characteristics of the integrally molded body are collectively shown in Table 1. We confirmed that the obtained integrally molded body (C) 1 was a molded article having a good appearance with high designability without appearance defects such as blur and fiber breakage, but a protruding convex shape was not formed on the laminate (A) 2, and a component installation space could not be secured.

### Comparative Example 5

An integrally molded body was prepared in the same manner as in Comparative Example 1 except that the convex shape of the mold was changed to 5.0 mm. The characteristics of the integrally molded body 1 are collectively shown in Table 1.

In the obtained integrally molded body (C) 1, a protruding convex shape was formed in a desired region of the laminate (A) 2, and a flat portion (E) was provided at the maximum height position of the convex portion, but appearance defects such as blur and fiber breakage occurred in a partial region of the laminate (A) 2.

### Comparative Example 6

An integrally molded body was prepared in the same manner as in Comparative Example 1 except that the PAN-based unidirectional prepreg obtained in Material Composition Example 1, the thermoplastic adhesive film (D) obtained in Material Composition Example 2, and the foamed resin core of Material Composition Example 7 were each adjusted to a size of 400 mm square, and then lamination was performed in the order of [PAN-based unidirectional prepreg 0°/PAN-based unidirectional prepreg 90°/foamed resin core layer/PAN-based unidirectional prepreg 90°/PAN-based unidirectional prepreg 0°/thermoplastic adhesive film] to have a sandwich structure, and the convex shape of the mold was changed to 5.0 mm. The characteristics of the integrally molded body 1 are collectively shown in Table 1.

In the obtained integrally molded body (C) 1, a protruding convex shape was formed in a desired region of the laminate (A) 2, and a flat portion (E) was provided at the maximum height position of the convex portion, but appearance defects such as blur and fiber breakage occurred in a partial region of the laminate (A) 2.

### Example 5

An integrally molded body was prepared in the same manner as in Example 2 except that the convex shape of the mold was changed to 3.8 mm. The characteristics of the integrally molded body 1 are collectively shown in Table 1.

In the obtained integrally molded body (C) 1, a protruding convex shape was formed in a desired region of the laminate (A) 2, and a flat portion (E) was provided at the maximum height position of the convex portion. The flat portion (E) was completely flat, and a molded article having a good appearance with high designability without appearance defects such as blur and fiber breakage on the design surface was obtained.

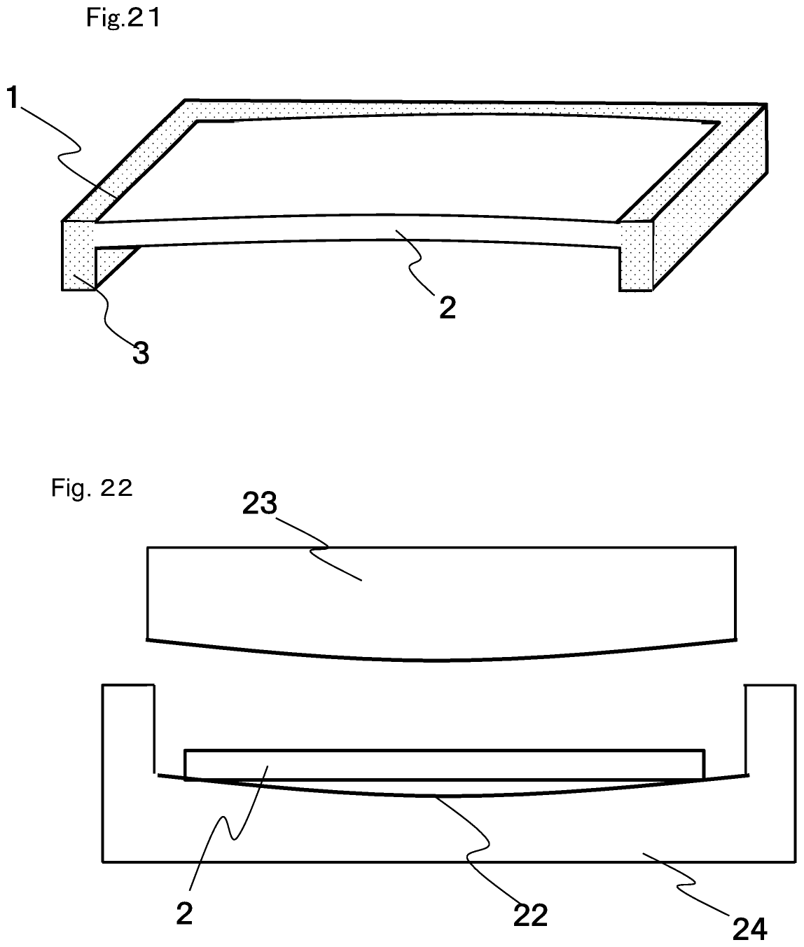

TABLE 1

| | | Unit | Example 1 | Example 2 | Example 3 | Example 4 | Example 5 |
|---|---|---|---|---|---|---|---|
| Constituent | Skin layer of | — | Material | Material | Material | Material | Material |
| member | laminate (A) | | Composition | Composition | Composition | Composition | Composition |
| | | | Example 1 | Example 1 | Example 1 | Example 1 | Example 1 |
| | | | | | | Material | |
| | | | | | | Composition | |
| | | | | | | Example 9 | |
| | Core layer of | — | Material | Material | Material | Material | Material |
| | laminate (A) | | Composition | Composition | Composition | Composition | Composition |
| | | | Example 8 | Example 7 | Example 7 | Example 8 | Example 7 |
| | Thermoplastic | — | Material | Material | Material | Material | Material |
| | resin layer (D) | | Composition | Composition | Composition | Composition | Composition |
| | | | Example 2 | Example 2 | Example 2 | Example 2 | Example 2 |
| | Resin member (B) | — | Material | Material | Material | Material | Material |
| | | | Composition | Composition | Composition | Composition | Composition |
| | | | Example 3 | Example 3 | Example 3 | Example 3 | Example 3 |
| | Shape of integrally | — | FIG. 19 | FIG. 8 | FIG. 21 | FIG. 19 | FIG. 8 |
| | molded body | | | | | | |
| | Specific gravity of | — | 1.16 | 1.16 | 1.16 | 1.40 | 1.16 |
| | laminate (A) | | | | | | |
| Integrally | Integration method | — | Injection molding | Injection molding | Injection molding | Injection molding | Injection molding |
| molded | Convex shape | mm | 1.0 | 1.0 | R800 | 1.0 | 3.8 |
| body | provided on mold | | | | | | |
| | Height of flat | | 1.0 | 1.0 | 2.0 | 1.0 | 3.8 |
| | portion (E) | | | | | | |
| | Height of | | 0.1 | 0.1 | 0.3 | 0.1 | 0.1 |
| | intersection (F) | | | | | | |
| | Distance (T) between | | 0.9 | 0.9 | 1.7 | 0.9 | 3.7 |
| | flat portion (E) | | | | | | |
| | and intersection (F) | | | | | | |

| | | | | | | |
|---|---|---|---|---|---|---|
| Total thickness (mm) | | 1.15 | 1.15 | 1.15 | 1.15 | 1.15 |
| of laminate (A) | | | | | | |
| Appearance on design | — | ∘ | ∘ | ∘ | ∘ | ∘ |
| surface side of | | | | | | |
| laminate (A) 2 | | | | | | |
| Overall evaluation | — | A | A | A | A | A |

TABLE 2

| | | | Comparative | Comparative | Comparative | Comparative | Comparative | Comparative |
|---|---|---|---|---|---|---|---|---|
| | | Unit | Example 1 | Example 2 | Example 3 | Example 4 | Example 5 | Example 6 |
| Constituent | Skin layer of | — | Material | Material | Material | Material | Material | Material |
| member | laminate (A) | | Composition | Composition | Composition | Composition | Composition | Composition |
| | | | Example 1 | Example 1 | Example 1 | Example 1 | Example 1 | Example 1 |
| | Core layer of | — | — | — | — | — | — | Material |
| | laminate (A) | | | | | | | Composition |
| | | | | | | | | Example 7 |
| | Thermoplastic | — | Material | Material | Material | Material | Material | Material |
| | resin layer (D) | | Composition | Composition | Composition | Composition | Composition | Composition |
| | | | Example 2 | Example 2 | Example 2 | Example 2 | Example 2 | Example 2 |
| | Resin member (B) | — | Material | Material | Material | Material | Material | Material |
| | | | Composition | Composition | Composition | Composition | Composition | Composition |
| | | | Example 3 | Example 3 | Example 3 | Example 3 | Example 3 | Example 3 |
| | Shape of integrally | — | FIG. 1 | FIG. 1 | FIG. 1 | FIG. 16 | FIG. 1 | FIG. 8 |
| | molded body | | | | | | | |
| | Specific gravity of | — | 1.57 | 1.57 | 1.57 | 1.57 | 1.57 | 1.16 |
| | laminate (A) | | | | | | | |
| Integrally | Integration method | — | Injection | Injection | Injection | Injection | Injection | Injection |
| molded body | | | molding | molding | molding | molding | molding | molding |
| | Convex shape | mm | 1.0 | 2.5 | 3.0 | 0.0 | 5.0 | 5.0 |
| | provided on mold | | | | | | | |
| | Height of flat | | 1.0 | 2.5 | 3.0 | 0.0 | 5.0 | 5.0 |
| | portion (E) | | | | | | | |
| | Height of | | 0.2 | 0.2 | 0.3 | 0.0 | 0.3 | 0.3 |
| | intersection (F) | | | | | | | |
| | Distance (T) between | | 0.8 | 2.3 | 2.7 | 0.0 | 4.7 | 4.7 |
| | flat portion (E) and | | | | | | | |
| | intersection (F) | | | | | | | |

| | | | | | | | |
|---|---|---|---|---|---|---|---|
| Total thickness (mm) | | 1.15 | 1.15 | 1.15 | 1.15 | 1.15 | 1.15 |
| of laminate (A) | | | | | | | |
| Appearance on design | — | x | x | x | ∘ | x | x |
| surface side of laminate (A) 2 | | | | | | | |
| Overall evaluation | — | B′ | B′ | B′ | B | C | C |

### INDUSTRIAL APPLICABILITY

Our integrally molded body can be effectively used in interiors and exteriors of motor vehicles, electric and electronic device housings, bicycles, structural materials for sports goods, aircraft interior materials, transportation boxes and the like. Among them, they can be particularly used in a personal computer housing (for example, a laptop personal computer housing having a side length of 200 mm to 500 mm, or 200 mm to 400 mm) in which weight reduction and thickness reduction is highly demanded.

1-6. (canceled)

7. An integrally molded body comprising:
a laminate (A) having a design surface on one side; and
a resin member (B) joined to an outer peripheral side surface of the laminate (A) and contains discontinuous fibers and a thermoplastic resin, wherein
the laminate (A) includes surface layers and a core layer, and has a sandwich structure in which the core layer is sandwiched between the surface layers,
each of the surface layers includes a member composed of a fiber-reinforced resin member containing continuous reinforcing fibers and a resin,
the core layer is any one of a film, a foam, and a porous base material,
a convex portion protruding toward the design surface side is formed in a partial region of the laminate (A),
a flat portion (E) is provided at a maximum height position of the convex portion, and
a distance between an extension line extended from the flat portion (E) in an in-plane direction of the flat portion (E) and an intersection (F) at which a line moved from the extension line in a direction perpendicular to the flat portion (E) intersects the resin member (B) is 0.05 to 4.0 mm.

8. The integrally molded body according to claim 7, wherein
the laminate (A) has a non-design surface on a side opposite to the design surface and a thermoplastic resin layer (D) on the non-design surface,
the resin member (B) has a joint surface with the outer peripheral side surface of the laminate (A) and a joint surface with the thermoplastic resin layer (D), and
the laminate (A) and the resin member (B) are joined with the thermoplastic resin layer (D) interposed therebetween.

9. The integrally molded body according to claim 7, wherein a fitting portion into which the resin member (B) enters is provided in a part of the core layer.

10. The integrally molded body according to claim 9, wherein
the core layer is the porous base material,
the laminate (A) has a first joint portion joined to the resin member (B), the first joint portion provided at least in a partial region of an outer peripheral portion of the laminate (A),
the first joint portion has a stepped portion in an in-plane direction of the laminate (A), and
the stepped portion has an inclined surface having an angle θ of 10° to 80° with respect to an in-plane direction of the flat portion (E) provided in the laminate (A).

11. The integrally molded body according to claim 10, wherein a porosity of the porous base material at the first joint portion is lower than a porosity of the porous base material at a region other than the first joint portion.

12. The integrally molded body according to claim 7, wherein the laminate (A) has a rectangular shape in a top view.

13. The integrally molded body according to claim 8, wherein the laminate (A) has a rectangular shape in a top view.

14. The integrally molded body according to claim 9, wherein the laminate (A) has a rectangular shape in a top view.

15. The integrally molded body according to claim 10, wherein the laminate (A) has a rectangular shape in a top view.

16. The integrally molded body according to claim 11, wherein the laminate (A) has a rectangular shape in a top view.
